(19) United States
(12) Patent Application Publication
(10) Pub. No.: US 2011/0102375 A1
(43) Pub. Date: May 5, 2011

(54) OPTICAL TOUCH MODULE

(75) Inventors: Yun-Cheng Liu, Taipei County (TW); Chien-Hung Lin, Taoyuan County (TW); Bo-Yi Wu, Taipei County (TW); Chen-Kuan Lin, Taichung County (TW); Kuan-Chun Hsieh, Taipei County (TW); Yi-Chien Lin, Taipei City (TW)

(73) Assignee: QUANTA COMPUTER INC., Tao Yuan Shien (TW)

(21) Appl. No.: 12/762,412

(22) Filed: Apr. 19, 2010

(30) Foreign Application Priority Data
Oct. 29, 2009 (TW) 98136630

(51) Int. Cl. G06F 3/042

(52) U.S. Cl. 345/175

(57) ABSTRACT

An optical touch module includes a display panel, an optical sensor and a light emitting unit. The optical sensor is disposed on a corner of the display panel. The light emitting unit is disposed on the optical sensor and includes a light emitting member and a compensating member. The light emitting member emits light with a first light strength along a first direction and light with a second light strength along a second direction, wherein the first light strength is greater than the second light strength. The compensating member is disposed on a side of the light emitting member. After the lights pass through the compensating member, the second light strength is increased.

This Application claims priority of Taiwan Patent Application No. 098136630, filed on Oct. 29, 2009, the entirety of which is incorporated by reference herein.

### BACKGROUND OF THE INVENTION

1. Field of the Invention

The invention relates to an electronic device and an optical touch module thereof.

2. Description of the Related Art

Referring to FIG. 1, the conventional optical touch module 1 comprises a display panel 10, a reflecting unit 20, two optical sensors 30 and two light emitting units 40. The reflecting unit 20 is disposed around three sides of the display panel 10. The two optical sensors 30 are respectively disposed on two adjacent corners of the upper portion of the display panel 10, and the two light emitting units 40 are respectively disposed on the two optical sensors 30.

The light emitted by the light emitting unit 40 is reflected by the reflecting unit 20 and enters the optical sensors 30 (i.e. captured by the optical sensor 30). When a user touches a position on the display panel 10, a light emitted toward the position is not able to be reflected back to the optical sensors 30 due to a light path of the light is blocked. Therefore, a dark spot is formed on the image captured by the optical sensor 30, and coordinate of the position can be calculated by the optical touch module 1 according to the data of the dark spot.

However, the light paths from the light emitting unit 40 toward the reflecting unit 20 are uneven, causing variations in light strength and light decay. The longer the light path, the greater the light decay and the weaker the light strength. As a result, lights received by the optical sensors 30 may have various light strengths. For example, referring to the light emitting unit 40 at the top left corner in FIG. 1, the light path toward point A is longer than the light path toward point B. Thus, light decay of the light toward point A is greater than that of the light toward point B, and light strength of the light toward point A is weaker than that of the light toward point B while reaching the reflecting unit 20. Furthermore, the light paths for lights reflected by the reflecting unit 20 toward the optical sensors 30 are also different in length. Thus, the light strengths of the reflected light received by the optical sensors 30 from different positions may have significant differences, causing incorrect determinations. Also, in addition to the length of the light paths, as shown in FIG. 2, normally the light emitting unit 40 has Lambertian distribution. Note that in FIG. 2, X depicts the light distribution along the X direction, and Y depicts the light distribution along the Y direction. Referring to FIG. 2, light distribution of the light emitting unit 40 changes according to different angles, wherein the greater the angle formed between the light and the optical axis X3, the weaker the light strength of the light. Referring to top left corner of the light emitting unit 40 in FIG. 1, the angle α1 between the light emitted toward point A and the optical axis X3 is smaller than the angle α2 between the light emitted toward point B and the optical axis X3. Thus, the light strength of the light emitted toward point A is greater than the light strength of the light emitted toward point B from the light emitting unit 40. However, taking the different light paths (ex. distance from the light emitting unit 40 to the point A is longer than that of the light emitting unit 40 to the point B) and reflection coefficient of the reflecting unit 20 into consideration, it is possible that the light strength of the light toward point A may be weaker than that of the light strength of the light toward point B while being captured by the optical sensors 30.

Variation of light strength may be attributed to different lengths of light paths or different light distributions of the light emitting unit 40, both of which, may cause the optical sensor 30 to make an incorrect determination. That is, the optical sensor 30 may not be able to determine whether the dark spot is formed due to touching or reflected light with a long light path.

### BRIEF SUMMARY OF THE INVENTION

Accordingly, an optical touch module is provided. An optical touch module comprises a display panel, an optical sensor and a light emitting unit. The optical sensor is disposed on a corner of the display panel. The light emitting unit is disposed on the optical sensor and comprises a light emitting member and a compensating member. The light emitting member emits light with a first light strength along a first direction and light with a second light strength along a second direction, wherein the first light strength is greater than the second light strength. The compensating member is disposed on a side of the light emitting member. After the lights pass through the compensating member, the second light strength is increased.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional optical touch module;

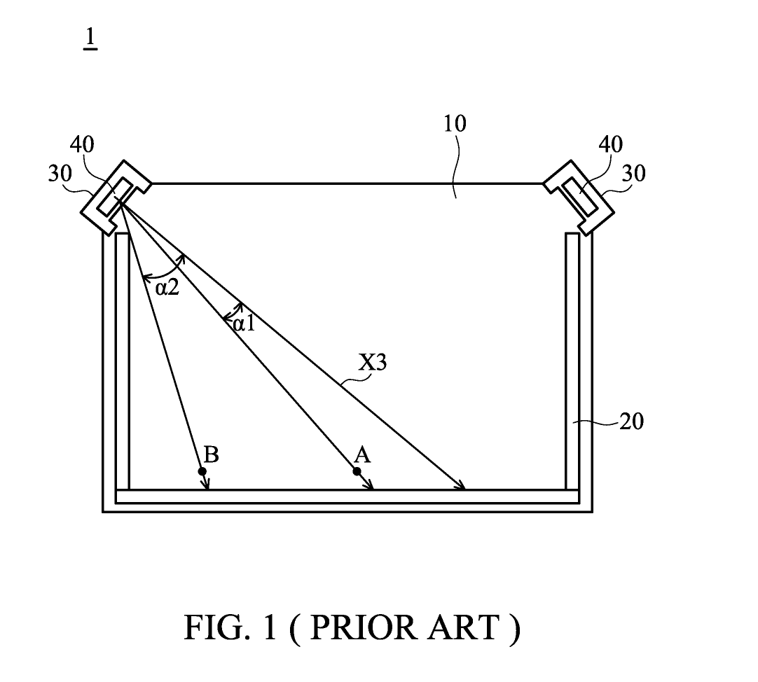

FIG. 2 is a diagram showing light distribution of a conventional optical touch module;

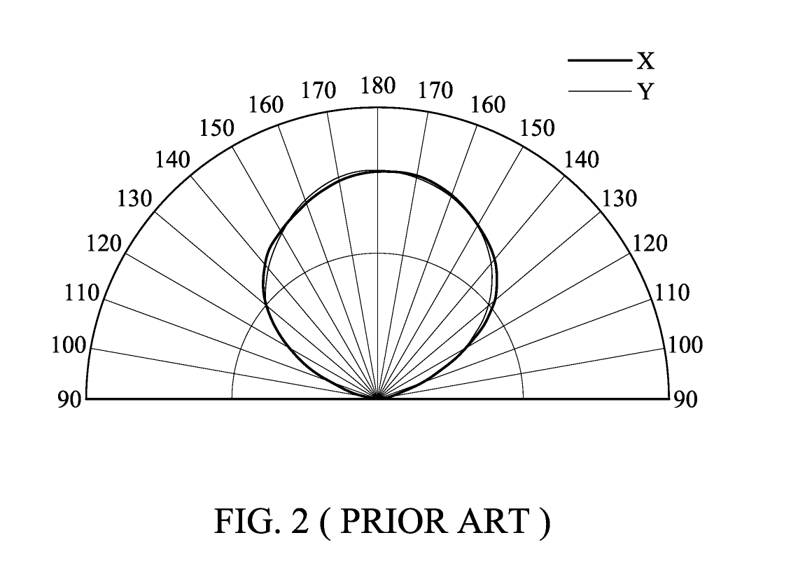

FIG. 3 is a schematic view of a first embodiment of an optical touch module of the invention;

FIG. 4A is a top view of an optical sensor and a light emitting unit of the optical touch module of the first embodiment of the invention;

FIG. 4B is a side view of an optical sensor and a light emitting unit of the optical touch module of the first embodiment of the invention;

FIG. 5 is a diagram showing light distribution of the optical touch module of the invention; and

FIG. 6 is a schematic view of a second embodiment of the optical touch module of the invention.

### DETAILED DESCRIPTION OF THE INVENTION

### First Embodiment

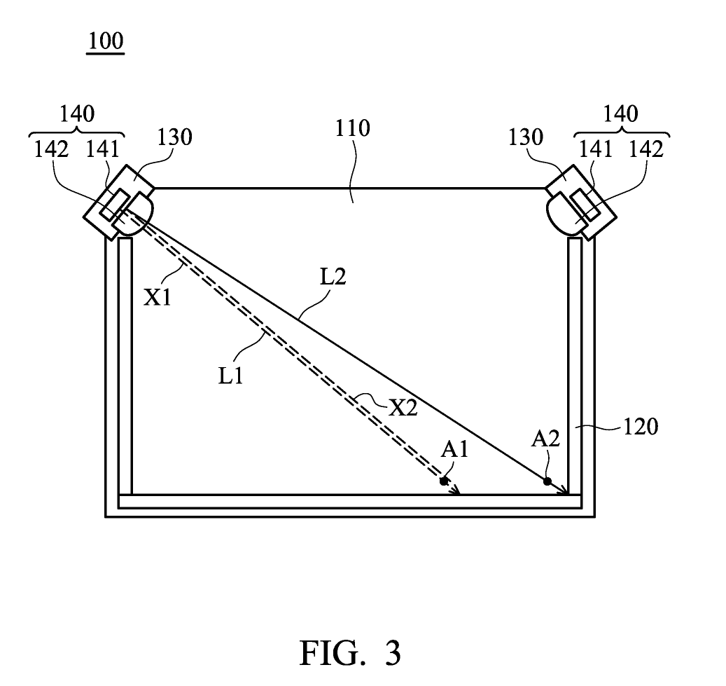

Referring to FIG. 3, the optical touch module 100 of the invention comprises a display panel 110, a reflecting unit 120, two optical sensors 130 and two light emitting units 140.

The reflecting unit 120 is disposed around the three sides of the display panel 110. The two optical sensors 130 are respectively disposed on the two adjacent corners of the top portion of the display panel 110. The two light emitting units 140 are respectively disposed on the two optical sensors 130. The light emitting units 140 emits light to the reflecting unit 120, and light is reflected thereby to enter the optical sensors 130.

Each of the light emitting units 140 comprises a light emitting member 141 and a compensating member 142. The light emitting unit 140 on the left side of the display panel 110 is used as an example. The light emitting member 141, for example a light emitting diode, has a first optical axis X1, and the first optical axis X1 passes through the point A1, such that the light L1 emitted toward point A1 has a greater light strength than others emitted toward other directions (ex. the light L2 toward point A2 as shown in FIG. 3). Moreover, because the point A2 is located at the lower right corner of the display panel 110, the light path of the light L2 to the point A2 is longer than the light path of the light L1 to the point A1. Thus, the light decay of the light L2 is greater when the light L2 reaches the point A2 than the light decay of the light L1 when the light L1 reaches the point A1. Therefore, the described deficiencies may cause significant differences in light strength of the light L1 and the light L2 reflected back to the optical sensor 130.

A compensating member 142 is utilized to solve the described problems. The compensating member 142 is an optical lens, such as a condense lens, which is disposed on a side of the light emitting member 141. After passing through the compensating member 142, the light emitted by the light emitting member 141 is condensed toward a specific direction, such that the light strength of the light passing toward the specific direction is thus enhanced. In other words, the problem of significant differences in light strength which may cause incorrect determinations due to different light paths could be overcome by corresponding or aligning the specific direction to a specific position with longer light path. The light strength of the light reflected back to the optical sensor 130 through the specific position along the specific direction is enhanced about the same as the light strength of the light reflected back to the optical sensor 130 through the adjacent position, thus lower the chance of incorrect determinations. In an embodiment, the specific direction corresponds to a diagonal direction of the display panel 110 (such as the direction of the light L2), which also corresponds to the point A2. It should be noted that the light L1 does not have to correspond to the direction of the first optical axis X1. The above description is only an example to solve the described problem. The light L1 should be interpreted as the light not along the same direction of the light L2, or interpreted as the light adjacent to the light L2.

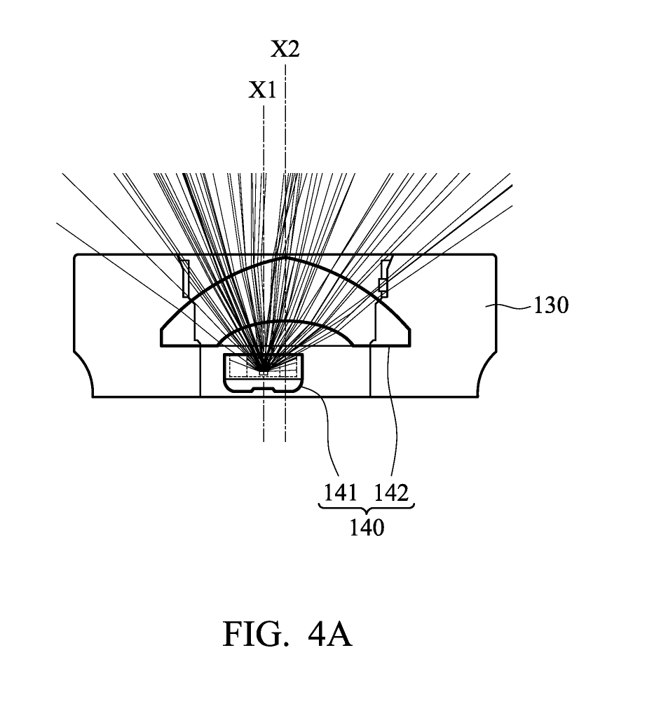

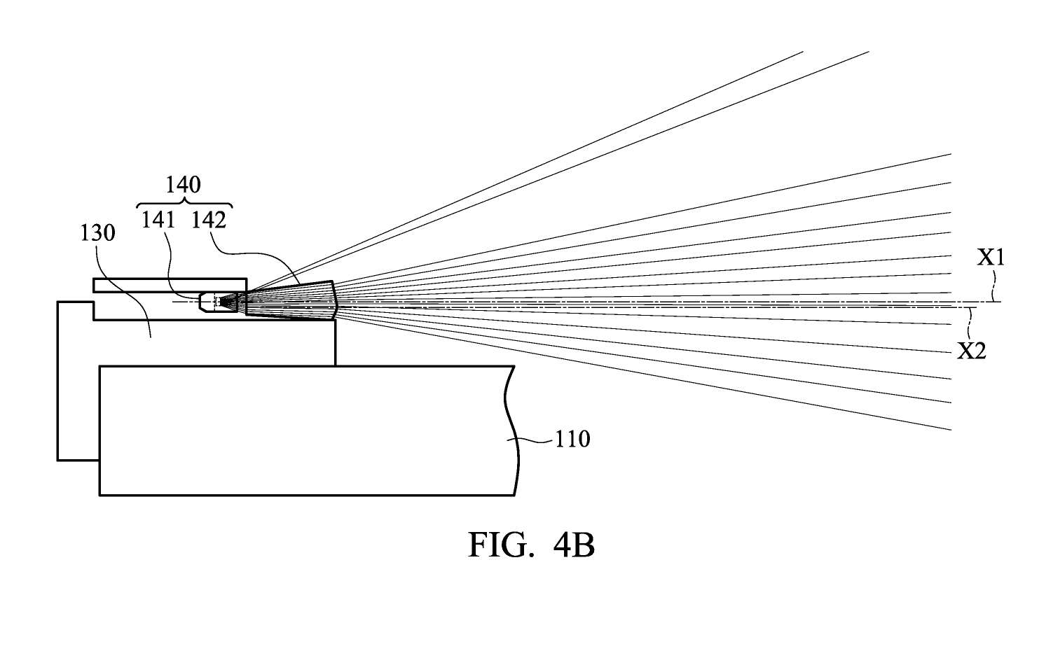

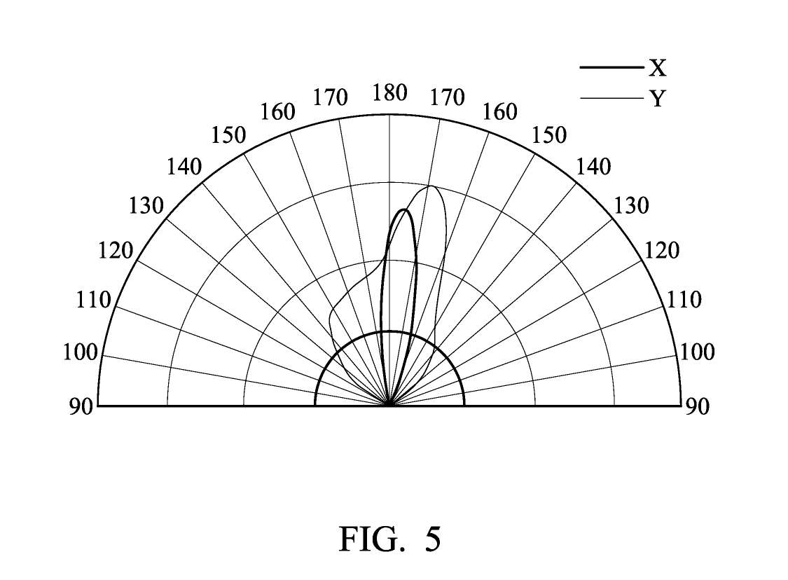

Referring to FIGS. 4A and 4B, to solve the described problem, the first optical axis X1 of the light emitting member 141 is offset from the second optical axis X2 of the compensating member 142 along a horizontal direction (the horizontal direction parallel to the display panel 110). Further, as shown in FIG. 4B, the second optical axis X2 of the condense lens is also offset from the first optical axis X1 of the light emitting member 141 along a vertical direction (the vertical direction perpendicular to the display panel 110). In detail, the second optical axis X2 is located between the first optical axis X1 and the display panel 110 along a vertical direction. For such arrangement, the light distribution would be as shown in FIG. 5, wherein X depicts the light distribution along the X direction (horizontal direction) and Y depicts the light distribution along the Y direction (vertical direction). As shown, a portion of the light is clearly shown to be condensed toward the specific direction along the X direction (horizontal direction), and a majority of the light is condensed toward the specific direction along the Y direction (vertical direction). In other words, after the light emitted by the light emitting member 141 penetrates the compensating member 142, a portion of the light is condensed toward the specific direction due to the second optical axis X2. It should be noted that the direction of the second optical axis X2 should not be explained as the specific direction. Contrarily, the specific direction should be understood as corresponding to the direction toward the position which has the longer light path. As shown in FIG. 3, the specific direction for example is the direction toward point A2 (the light path of the light L2). The adjacent light (light not along the specific direction, such as the light L1) is condensed along the specific direction through the compensating member 142 to enhance the light strength of the light along the specific direction (the light L2), as shown in FIG. 4A. As such, the light strength of the light (the light L2) reflected back to the optical sensor 130 through the specific position (the point A2) along the specific direction is about the same as the light strength of the light reflected back to the optical sensor 130 through the adjacent position (the point A1) next to the specific position (the point A2). In addition, due to portions of light are condensed toward the specific direction, the overall luminous on the display panel 110 would be decreased especially along the X direction (horizontal direction). To overcome this problem, a majority of the light is condensed through the second optical axis X2 between the light emitting unit 140 and the display panel 110 along the Y direction (vertical direction), i.e. between the effective thickness of the reflecting unit 120, to increase overall luminous on the display panel 110. In other words, with the second optical axis X2 offset from the first optical axis X1 along the vertical direction, when the light which is not toward the specific direction (ex. the light L1) is condensed toward the specific direction along the horizontal direction, the light strength is not decreased.

Therefore, compensation for light in the horizontal direction and the vertical direction are accomplished. Also, overall luminous on the display panel 110 is maintained for improving detection ability of the optical sensor 130 with receiving relatively uniform light strengths.

### Second Embodiment

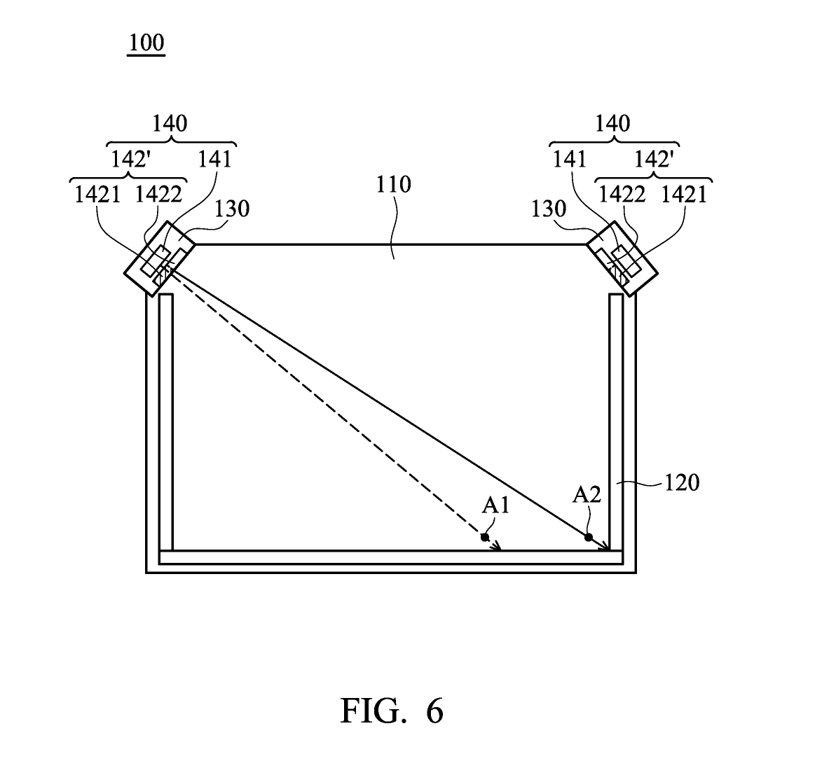

As shown in FIG. 6, the compensating member 142, and an optical lens disposed on a side of the light emitting member 141, comprises a first portion 1421 and a second portion 1422, wherein the transparency of the first portion 1421 is lower than that of the second portion 1422. The lights emitted by the light emitting member 141 pass the first portion 1421 to reach the point A1 (as shown in the dotted arrow in FIG. 6). That is, the light length the light L1 toward the point A1 is decreased or absorbed by the first portion 1421, and the light L2 is able to reach the point A2 which requires a longer light path through the second portion 1422 (as shown by solid arrow in FIG. 6). In an embodiment, the compensating member 142′ may comprise a gradient coating, which comprises a transparency degree which descends from an end to the other end of the lens.

In detail, the light L1 along the optical axis X1 is affected by the first portion 1421, causing the light strength of the light L1 decreased after passing through the fist portion 1421. Similarly, the light strength of the reflected light back to the optical sensor 130 therethrough is also decreased as well. Contrarily, the light L2 along the optical axis X2 passes through the second portion 1422 which has a relatively higher transparency than the first portion 1421, causing the light strength the light L2 only slightly decreased, and the light strength of the reflected light back to the optical sensor 130 therethrough is also slightly decreased compared with the light L1 passing through the first portion 1421. By decreasing the light strength of the light L1 via the compensating member 142′ to compensate those lights with longer light paths such as point A2, significant differences in light strength of the reflected lights can be avoided.

The first portion 1421 of the compensating member 142′ can be formed by a coating or printing process to have a semi-transparent surface, or can be formed by a sand blasting process to have a rough or textured surface.

It should be noted that the second embodiment can be applied separately, or it can be utilized with the first embodiment to enhance uniformity of the reflected light toward the optical sensor 130, thereby lowering the possibility of incorrect determinations.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical touch module, comprising:
a display panel;
an optical sensor disposed on a corner of the display panel; and
a light emitting unit disposed on the optical sensor, comprising:
a light emitting member emitting light with a first light strength along a first direction and light with a second light strength along a second direction, wherein the first light strength is greater than the second light strength; and
a compensating member disposed on a side of the light emitting member, wherein after the lights pass through the compensating member, the second light strength is increased.

2. The optical touch module as claimed in claim 1, further comprising a reflecting unit, wherein the lights reach the reflecting unit after passing through the compensating member, and the reflecting unit reflect the lights to be received by the optical sensor.

3. The optical touch module as claimed in claim 1, wherein the compensating member comprises an optical lens.

4. The optical touch module as claimed in claim 3, wherein the light emitting member has a first optical axis, the optical lens has a second optical axis, and the second axis is offset from the first optical axis along a horizontal direction.

5. The optical touch module as claimed in claim 4, wherein the optical lens is a condense lens for condensing the lights toward the second direction.

6. The optical touch module as claimed in claim 4, wherein the second optical axis is offset from the first optical axis along a vertical direction, and the second optical axis is between the first optical axis and the display panel.

7. The optical touch module as claimed in claim 3, wherein the optical lens comprises a gradient coating.

8. The optical touch module as claimed in claim 3, wherein the optical lens comprises a first portion and a second portion, the light along the first direction passes through the first portion and the light along the second direction passes through the second portion.

9. The optical touch module as claimed in claim 8, wherein transparency of the first portion is lower than that of the second portion.

10. The optical touch module as claimed in claim 9, wherein the first portion is formed by coating, printing or sand blasting processes.

11. The optical touch module as claimed in claim 9, wherein the first portion comprises a rough surface or a textured surface.

12. The optical touch module as claimed in claim 1, wherein the light along the first direction has a shorter light path than that of the light along the second direction.

13. The optical touch module as claimed in claim 1, wherein the optical touch module comprises two optical sensors respectively disposed on two adjacent corners of the display panel and the light emitting unit comprised two light emitting units respectively disposed on the optical sensors.

14. The optical touch module as claimed in claim 1, wherein the light emitting member is a light emitting diode.

15. The optical touch module as claimed in claim 1, wherein the second direction corresponds to a diagonal direction of the display panel.
